(19) United States
(12) Patent Application Publication
(10) Pub. No.: US 2025/0010520 A1
(43) Pub. Date: Jan. 9, 2025

(54) A METHOD TO RECUPERATE A BEAD BUNDLE ASSEMBLY OUT OF AN END-OF-LIFE TIRE

(71) Applicant: NV BEKAERT SA, Zwevegem (BE)

(72) Inventors: Hao TIAN, Jiangyin City (CN); Yiwen LUO, Shanghai (CN)

(73) Assignee: NV BEKAERT SA, Zwevegem (BE)

(21) Appl. No.: 18/709,966

(22) PCT Filed: Nov. 25, 2022
(86) PCT No.: PCT/EP2022/083323

§ 371 Date: May 14, 2024

(30) Foreign Application Priority Data
Dec. 13, 2021 (WO) PCT/CN2021/137420

(51) Int. Cl. B29B 17/02; B29L 30/00

(52) U.S. Cl. CPC B29B 17/02; B29B 2017/0217; B29L 2030/00

(57) ABSTRACT

A method of recuperating a bead bundle assembly out of an end-of-life tire is provided, the method comprises several steps including: selecting an end-of-life tire having a tire identification; taking out the bead bundle assembly with or without a rubber layer remaining thereon, without plastic deformation of the bead bundle assembly; identifying each bead bundle assembly with at least said tire identification; and finally storing the bead bundle assembly. The invention provides a solution of optimizing the value of an end-of-life tire.

### TECHNICAL FIELD

The invention relates to a method of recuperating a bead bundle assembly out of an end-of-life tire. The invention also relates to a bead bundle assembly out of an end-of-life tire and its application.

### Background Art

Every year there are about 1 billion end-of-life tires worldwide. The recycling of the end-of-life tires is meaningful for preserving the environment and natural resources for sustainable development.

A radial tire normally comprises a tread, at least one belt layer, at least one carcass layer and a pair of beads, wherein the belt layer and carcass layer are reinforced by steel cords or polyester cords, the bead is reinforced by a bead ring formed by a steel wire or a group of steel wires wound as a bundle.

One of the recycling ways is recycling the rubber, the rubber of the end-of-life tires is recycled by being converted into new materials, fuels or recycled rubber.

Another of the recycling ways is recycling the tire, the tire is re-treaded to be a new tire. The tread of the end-of-life tire is removed, and a new tread is rebuilt, as thus a tire is recycled.

A third of the recycling ways is recycling the bead wire, the bead wire is drawn out of the tire for recycling the steel. The rubber of the tire can also be recycled after the recycling of the bead wire.

CN107553778 discloses a method for drawing the bead wire out of the end-of-life tire. The bead wire is drawn and thereby wound on a drawing roller, and then the wound bead wire is removed from the drawing roller. The bead wire from the tire is treated as waste steel wire for recycling the steel.

It is still desired to have more recycling ways to optimize the value of an end-of-life tire.

### DISCLOSURE OF INVENTION

The primary object of the invention is to provide a new recycling way of an end-of-life tire.

The first object of the invention is to provide a method to recuperate a bead bundle assembly out of an end-of-life tire.

The second object of the invention is to provide a bead bundle assembly recuperated from an end-of-life tire.

The third object of the invention is to provide a tire reinforced by a recuperated bead bundle assembly.

According to the first aspect of the invention, a method of recuperating a bead bundle assembly out of an end-of-life tire is provided, wherein the end-of-life tire comprises a carcass ply and a pair of bead bundle assembly, each bead bundle assembly comprises a bead ring with or without a fabric cover, the carcass ply is turned up outward of each bead bundle assembly thereby forming a pair of carcass ply turn-up, the carcass ply and a pair of bead bundle assembly are embedded in rubber, the method comprises the following steps:
#10 selecting an end-of-life tire having a tire identification;
#30 taking out the bead bundle assembly with or without a rubber layer remaining thereon, without plastic deformation of the bead bundle assembly;
#50 identifying each bead bundle assembly with at least the tire identification;
#70 storing the bead bundle assembly.

The invention provides a new solution of recycling the end-of-life tire, particularly the invention provides a solution of recycling the bead bundle assembly. Rather than existing technology of recycling the steel of the bead wire of the bead bundle assembly of an end-of-life tire, the invention recycles the bead bundle assembly and optimizes the value of the end-of-life tire. The bead wire of the bead ring is normally coated with bronze for promoting the adhesion with rubber. However, the copper and the tin from the bronze coating are not easy to be removed when recycling the steel from the bead wire, this makes the steel recycled from the bead wire having un-desired impurity of copper and tin, as the result, the wire rod made of the recycled steel has a relatively poor drawing ability, and thus the wire rod made of the recycled steel can't be reused for steel wire for reinforcing a tire, therefore the reuse of the steel recycled from the bead wire is limited. The invention solves the drawback. The invention of recycling the bead bundle assembly for a new tire saves the energy and optimizes the value of an end-of-life tire.

Tire identification is very crucial for the invention. Tires have various sizes and constructions, and different tires may have different bead bundle assembly. The recycled bead bundle assembly shall be reused in a new tire having the same size and construction as the original tire from which the bead bundle assembly is recuperated. Thus the tire identification is very important. The tire identification shall be recorded before the recuperation operation, and the tire identification shall be put on the recuperated bead bundle assembly. This ensures that the recuperated bead bundle assembly can be reused correctly. The tire identification includes at least the information of the tire size, the tread pattern and the tire brand. In step #50, the tire identification can be put on the recuperated bead bundle assembly by a sticky label printed with tire identification information or a QR code with the tire identification information behind or a Radio Frequency Identification tag pre-set with the tire identification information.

According to the invention, the bead bundle assembly taken out of the end-of-life tire can be realized by two main steps, wherein one step is a rough cut to take out a part containing the bead bundle assembly, and another step is a precise cut to remove the superfluous rubber till the rubber remaining upon the bead bundle assembly is as predetermined. Alternatively, the bead bundle assembly taken out of the end-of-life tire can be realized by one main step of direct precise cut which recuperates the bead bundle assembly with a predetermined rubber layer remaining thereon directly out of an end-of-life tire. For sure, no rubber layer remaining upon the bead bundle assembly is also available for the present invention.

Therefore, step #30 comprises the sub step:
#32 cutting out the bead bundle assembly from the end-of-life tire, wherein a predetermined rubber layer remaining upon the bead bundle assembly.

Alternatively, step #30 comprises the sub steps:
#34 cutting out a part containing the bead bundle assembly from the end-of-life tire, wherein the bead bundle assembly is enveloped by a rubber cover;
#36 thinning the rubber cover to a predetermined rubber layer thickness.

According to the invention, step #32, #34 or #36 is performed by means of one out of the following: water jet cutting, laser cutting, vibrating cutter, wire saw, band saw, circular saw, blade saw, high-pressure gas jet, sand blasting or a combination thereof. Step #34 and step #36 can be performed by the same or different means. The selection of the means depends on the construction of the specific tire and bead bundle assembly and the demand of the rubber layer remaining upon the bead bundle assembly.

Be sure that the operation of step #30, including its sub steps, shall not bring any plastic deformation to the bead bundle assembly.

The cutting of step #34 can be started at the portion of the tire close to the bead bundle assembly. Alternatively, the cutting of step #34 can be started at the shoulder position of the tire.

Preferably, the cutting of step #34 is realized by the sub step:
#34a wherein the cutting is through the carcass ply turn-up to separate a part containing the bead bundle assembly from the end-of-life tire.

Alternatively, the cutting of step #34 is realized by the sub step:
#34b wherein the cutting is along the portion between the carcass ply turnup and the bead bundle assembly, and further through the bead filler towards the bead bundle assembly to separate a part containing the bead bundle assembly from the end-of-life tire.

For the invention, preferably a thin layer of rubber is remaining upon the bead bundle assembly after step #30, this will contribute to the adhesion performance of the bead bundle assembly with the rubber for the new tire. Preferably, the rubber layer remaining upon the bead bundle assembly has a thickness of no more than 3 mm.

According to the invention, step #30 is followed by steps:
#40 comparing one or more of the following geometrical properties of the bead bundle assembly: bead diameter at rim seat, width, height, bead angle and roundness, to the specification;
#46 rejecting any bead bundle assembly that is outside the specification, while keeping the bead bundle assembly that is inside the specification.

The above step #40 is for identifying the quality of the bead bundle assembly for the further reuse in a new tire by comparing the geometrical properties of the bead bundle assembly to the specification, i.e., the specification of the bead bundle assembly of a tire. This could be done in any of the existing non-destructive methods such as X-ray measurement. The bead bundle assembly inside the specification is kept for further processing.

Optionally, step #40 is followed by step:
#42 verifying the mechanical properties of the bead bundle assembly.

This is also for identifying the quality of the bead bundle assembly for the further reuse in a new tire. This could be done in any of the existing nondestructive methods. The bead bundle assembly inside the specification is kept for further processing. Alternatively, step #42 can be done prior to step #40.

Normally, for a PCR tire, the bead bundle assembly has a bead ring without fabric cover on the bead ring; for a TBR tire, mostly the bead bundle assembly has a bead ring with a fabric cover, while only a few TRR tire has the bead bundle assembly with the bead ring only without fabric cover.

In case the bead bundle assembly comprises a bead ring with a fabric cover, step #40 or step 42 is followed by step: #44 verifying if any damage is incurred to the fabric cover, removing the original fabric cover and applying a new fabric cover when the original fabric cover is damaged.

Alternatively, step #44 can be done prior to step #40 or step 42.

The bead bundle assembly rebuilt with a new fabric cover is kept for further processing.

Preferably, step #50 is followed by step:
#60 applying an adhesion promoting layer on the rubber layer of bead bundle assembly or on the bead bundle assembly.

When the recuperated bead bundle assembly has a rubber layer remaining thereon, the adhesion promoting layer is applied on the rubber layer. When the recuperated bead bundle assembly has no rubber layer remaining thereon, the adhesion promoting layer is applied on the bead bundle assembly.

The adhesion promoting layer is applied for improving the adhesion performance of the bead bundle assembly with the rubber of a new tire. Preferably, the adhesion promoting layer is glue or rubber solution with a thickness of less than 2 mm. The glue could be any one of the existing glues for promoting the adhesion between the steel or the fabric and the rubber or between the rubber and the rubber, for example Chemlok glue for promoting the adhesion between the steel and the rubber. The adhesion promoting layer can be applied by brushing manually or automatically.

The recuperated bead bundle assembly taken out of an end-of-life tire is stored, preferably in an environment with a controlled temperature of less than 28 degree and a controlled humidity of less than 55%.

For the invention, the end-of-life tire means the tire is a used tire. For sure the invention is also possible to be exploited for a fresh tire. Carcass ply comprises at least one carcass layer which is a rubber layer reinforced by steel cords or polyester cords or other reinforcement elements. The bead bundle assembly can be any one of existing bead bundle assembly. The bead bundle assembly comprises one or more bead rings including multiple bead rings. The bead ring could be any one of the existing bead rings. For example, bead ring is formed by a metal wire or a steel wire or a group of metal wires or steel wires wound as a bundle. Bead filler is known in the art, and it is connecting with the bead bundle assembly.

According to a second aspect of the invention, a method for making a tire is provided, wherein the tire comprises a pair of bead bundle assembly, at least one of a pair of bead bundle assembly is recuperated from an end-of-life tire according to any of above methods.

According to a third aspect of the invention, a bead bundle assembly recuperated from an end-of-life tire according to any of above methods is provided.

According to a fourth aspect of the invention, the use of a bead bundle assembly recuperated from an end-of-life tire according to any of above methods in a newly built tire is provided.

According to a fifth aspect of the invention, a tire comprising a pair bead bundle assembly, at least one of said a pair of bead bundle assembly has been recuperated from an end-of-life tire according to any of above methods.

### BRIEF DESCRIPTION OF FIGURES IN THE DRAWINGS

FIG. 1 describes a cross-section of an end-of-life tire.

FIG. 2 describes one method of taking out a part containing the bead bundle assembly from an end-of-life tire.

FIG. 3 describes another method of taking out a part containing the bead bundle assembly from an end-of-life tire.

FIGS. 4a-4b describe a cross-section of the recuperated bead bundle assembly.

### MODE(S) FOR CARRYING OUT THE INVENTION

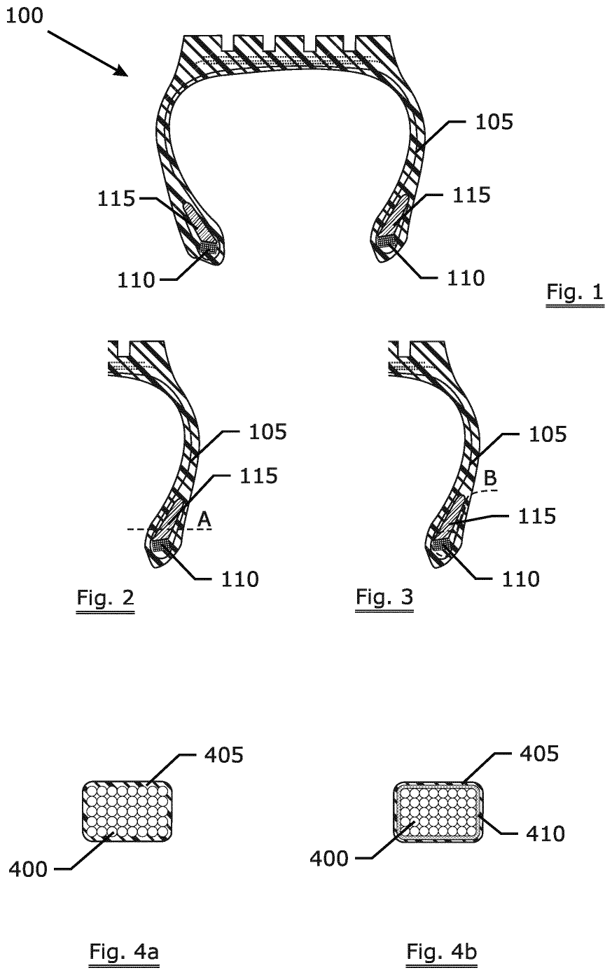

Selecting an end-of-life tire. FIG. 1 shows the cross-section of an end-of-life tire. The tire 100 comprises a carcass ply 105 and a pair of bead bundle assembly 110, the carcass ply 105 is turned up outward of each bead bundle assembly 110 thereby forming a pair of carcass ply turn-up, therefore the carcass ply turn up is one part of the carcass ply 105 starting from turning portion to the end of the carcass ply 105, the carcass ply 105 and a pair of bead bundle assembly 110 are embedded in rubber of the tire 110. A bead filler 115 is provided corresponding to each bead bundle assembly 110.

Recording the tire identification including at least the tire size, the tread pattern and the tire brand. A QR code is generated for detecting the information.

Cutting out each bead bundle assembly 110 enveloped by a rubber cover by the cutter or the water jet cutting. This is done by cutting through the carcass ply turn-up to separate a part containing the bead bundle assembly 110 from the tire; as line A shown in FIG. 2. For sure, this can alternatively be done by cutting along the portion between the carcass ply turn-up and the bead bundle assembly 110, and further through the bead filler 115 towards the bead bundle assembly 110 to separate a part containing the bead bundle assembly 110 from the tire, as line B shown in FIG. 3.

Thinning the rubber cover to a predetermined rubber layer thickness by the water jet cutting, thereby the superfluous rubber upon the bead bundle assembly 110 is removed without plastic deformation of the bead bundle assembly 110. This is for controlling the rubber remaining upon the bead bundle assembly 110 to be as predetermined, i.e., of no more than 3 mm, not too much. The thickest thickness of the rubber layer along the circumferential direction of the bead bundle assembly is deemed as the thickness of the rubber layer. The measurement of the thickness of the rubber layer is measuring the shortest distance from the surface of the rubber layer to the surface of the bead bundle assembly. FIG. 4a shows the cross-section of one recuperated bead bundle assembly with a thin rubber layer 405 upon the bead ring 400. FIG. 4b shows the cross-section of another embodiment of the recuperated bead bundle assembly comprising a bead ring 400 and a fabric cover 410 with a thin rubber layer 405 remaining thereon. In case there is any damage to the fabric cover only but no plastic deformation of the bead bundle assembly, the fabric cover shall be removed from the bead bundle assembly, and a new fabric cover shall be provided on the bead bundle assembly. Optionally, there could be no rubber layer remaining upon the bead bundle assembly.

Alternatively, the bead bundle assembly with or without a thin rubber layer can be recuperated from an end-of-life tire directly by water jet cutting.

Comparing one or more of the following geometrical properties of the recuperated bead bundle assembly: bead diameter at rim seat, width, height, bead angle and roundness to the specification; rejecting any bead bundle assembly that is outside the specification, while keeping the bead bundle assembly that is inside the specification. For the bead bundle assembly with a rectangular bead ring or a hexagon bead ring, the symmetry property of the bead bundle assembly shall be compared as well. Optionally, verifying the mechanical properties of the bead bundle assembly. This is to further ensure that the bead bundle assembly has the correct size and/or sufficient strength applicable for being reused in a new tire.

An adhesion promoting layer is applied on the surface of the thin rubber layer. In case there is no rubber layer remaining upon the bead bundle assembly, the adhesion promoting layer is applied on the surface of the bead bundle assembly. The adhesion promoting layer is glue or rubber solution with a thickness of less than 2 mm. The thickest thickness of the adhesion promoting layer along the circumferential direction of the recuperated bead bundle assembly is deemed as the thickness of the adhesion promoting layer. The measurement of the thickness of the adhesion promoting layer is measuring the shortest distance from the surface of the adhesion promoting layer to the surface of the rubber layer or to the surface of the bead bundle assembly in case there is no rubber layer remaining.

Then the qualified recuperated bundle assembly is put with a sticky label with the QR code with the tire identification behind, and it is stored in an environment with a controlled temperature of less than 28 degree and a controlled humidity of less than 55% prepared for a new tire making.

1. A method to recuperate a bead bundle assembly out of an end-of-life tire, said end-of-life tire comprising a carcass ply and a pair of bead bundle assembly, each bead bundle assembly comprising a bead ring with or without a fabric cover, said carcass ply being turned up outward of each bead bundle assembly thereby forming a pair of carcass ply turn-up, said carcass ply and a pair of bead bundle assembly being embedded in rubber, said method comprising the following steps:
#10 selecting an end-of-life tire having a tire identification;
#30 taking out the bead bundle assembly with or without a rubber layer remaining thereon, without plastic deformation of the bead bundle assembly;
#50 identifying each bead bundle assembly with at least said tire identification;
#70 storing the bead bundle assembly.

2. The method according to claim 1, wherein step #30 comprises the sub step:
#32 cutting out the bead bundle assembly from said end-of-life tire, wherein a predetermined rubber layer remaining upon the bead bundle assembly.

3. The method according to claim 1, wherein step #30 comprises the sub steps:
#34 cutting out a part containing the bead bundle assembly from said end-of-life tire, wherein the bead bundle assembly is enveloped by a rubber cover;
#36 thinning the rubber cover to a predetermined rubber layer thickness.

4. The method according to claim 2, wherein step #32, #34 or #36 is performed by means of one out of the following: water jet cutting, laser cutting, vibrating cutter, wire saw, band saw, circular saw, blade saw, high-pressure gas jet, sand blasting or a combination thereof.

5. The method according to claim 3, wherein the step #34 comprises the sub step:
#34a wherein said cutting is through said carcass ply turn-up to separate a part containing the bead bundle assembly from the end-of-life tire.

6. The method according to claim 3, wherein the step #34 comprises the sub step:
#34b wherein said cutting is along the portion between the carcass ply turn-up and said bead bundle assembly, and further through the bead filler towards the bead bundle assembly, to separate a part containing the bead bundle assembly from the end-of-life tire.

7. The method according to claim 1, wherein the rubber layer remaining upon the bead bundle assembly has a thickness of no more than 3 mm.

8. The method according to claim 1, wherein step #30 is followed by steps:
#40 comparing one or more of the following geometrical properties of the bead bundle assembly: bead diameter at rim seat, width, height, bead angle and roundness, to the specification;
#46 rejecting any bead bundle assembly that is outside the specification, while keeping the bead bundle assembly that is inside the specification.

9. The method according to claim 8, wherein step #40 is followed by step:
#42 verifying the mechanical properties of the bead bundle assembly.

10. The method according to claim 1, wherein for the bead bundle assembly comprising a bead ring with a fabric cover, step #40 or step 42 is followed by step:
#44 verifying if any damage is incurred to the fabric cover, removing the original fabric cover, and applying a new fabric cover when the original fabric cover is damaged.

11. The method according to claim 1, wherein in step #50 the tire identification is put on the bead bundle assembly by a sticky label printed with tire identification information or a QR code with the tire identification information behind or a Radio Frequency Identification tag pre-set with the tire identification information.

12. The method according to claim 1, wherein step #50 is followed by step:
#60 applying an adhesion promoting layer on the rubber layer of bead bundle assembly or on the bead bundle assembly.

13. The method according to claim 12, wherein said adhesion promoting layer is glue or rubber solution with a thickness of less than 2 mm.

14. A method for making a tire, said tire comprising a pair of bead bundle assembly, wherein at least one of said a pair of bead bundle assembly has been obtained according to the method according to claim 1.

15. A bead bundle assembly obtained according to the method according to claim 1.

16. The use of a bead bundle assembly obtained according to the method according to claim 1 in a newly built tire.

17. A tire comprising a pair bead bundle assembly, at least one of said a pair bead bundle assembly as obtained according to method according to claim 1.
